(19) United States
(12) Patent Application Publication
(10) Pub. No.: US 2003/0221922 A1
(43) Pub. Date: Dec. 4, 2003

(54) Automatic brake actuation system and method for vehicles

(76) Inventor: Robert W. Callow, Hampton Park (AU)

Correspondence Address: BIRCH STEWART KOLASCH & BIRCH, PO BOX 747, FALLS CHURCH, VA, 22040-0747, US

(21) Appl. No.: 10/372,821

(22) Filed: May 27, 2003

(30) Foreign Application Priority Data
Feb. 26, 2002 (AU) PS0764/02

(51) Int. Cl. F16D 69/00

(52) U.S. Cl. 188/265; 303/89

(57) ABSTRACT

An automatic parking brake actuation system for a truck or other heavy vehicle, including:

control means for receiving a first signal indicative of whether a driver's seat of the vehicle is occupied or not and for receiving a second signal indicative of whether a driver's door of the vehicle is open or closed, wherein the control means is adapted to transmit a brake actuation signal to a parking brake actuation mechanism of the vehicle when said first and second signals indicate that said driver's seat is not occupied and said driver's door is open.

### FIELD OF THE INVENTION

This invention relates to a safety apparatus and method for automatic actuation of park brakes of vehicles or disabling of machinery. The invention can be adopted for various types of vehicles that require a driver/operator. Examples of such vehicles include heavy machinery, road plant, farm vehicles, trains, mining vehicles, off road vehicles, trucks, buses and airport vehicles.

### BACKGROUND

Currently the actuation (or initiation of actuation) of vehicle parking brakes is left as a manual operation initiated by the driver of the vehicle. Omission of activating the park brake by drivers for various reasons has led to situations where a vehicle has become a “runaway”. This has caused death, serious injury, and expensive damage, particularly when the vehicle is a heavy vehicle eg trucks and buses.

In U.S. Pat. No. 5,120,980 to Fontaine, there is disclosed a seat cushion switch system which is disclosed but not generally known and to the applicant's knowledge is not in use in vehicle safety systems in Australia or elsewhere. This system includes a delay circuit with a general purpose time delay weight activated switch. A foam seat cushion contains wire mesh electrical switch closing contacts. Sitting or rising from the cushion opens and closes the switch A solid-state adjustable timer is also embedded in the cushion, or adjacent to the cushion. Its purpose is to delay the opening of the switch several seconds. A disclosed application for the device is to automatically lock an emergency brake in a delivery van. The invention's delay circuit allows the driver to bounce up and down on a bumpy road without setting off the switch.

Looking at the disclosed apparatus in detail there is described a resilient compressible apertured separator 1 which separates two wire mesh contact sheets 2 and 3 in which conductive contacts 4 are mounted on several opposing locations on the sheets 2 and 3. Holes 5 allow opposing contacts 4 which are preferably washers, to touch when separator 1 is compressed. In normal operation this would occur when a person sits on the device. Contacts 4 are electrically connected to the wire mesh of contact sheets 2 and 3. A delay circuit 7 is provided for delaying output of the switch signal.

An application of this prior art would be to provide a switch output signal for a vehicle emergency brake system configured to apply the emergency brakes when the driver lifted his weight off the scat cushion for more than a few seconds.

It is alleged that this total system adds a measure of safety to a delivery truck operation requiring numerous park and stop manoeuvres while the vehicle is running. However, a major disadvantage with such a system is that the operation of the park brake is on a single presumption of the intention of the driver. It does not allow the driver to be partially off the seat while driving or to be able to interpose a further cushion for driver comfort; there may be other reasons why the driver may not be in the normal seated position but the prior art seat cushion-switch cannot account for them. If considered impractical or inconvenient, the driver may decide to disable the seat switch, thus rendering it useless.

An additional disadvantage of the device of U.S. Pat. No. 5,120,980 is that no safe guard is provided against spurious seat switch activation or deactivation. This may result, for example, in an emergency brake being applied due to activation of the seat switch when the driver is partially out of the seat. Such spurious activation of the emergency brake could be very dangerous to the driver and other people on the road.

### SUMMARY OF THE INVENTION

The present invention provides an automatic brake actuation system for a vehicle, including:

control means for receiving a first signal indicative of whether a driver's seat of the vehicle is occupied or not and for receiving a second signal indicative of whether a driver's door of the vehicle is open or closed, wherein the control means is adapted to transmit a brake actuation signal to a brake actuation mechanism of the vehicle when said first and second signals indicate that said driver's seat is not occupied and said driver's door is open.

Preferably, the control means further receives a third signal indicative of an ignition status of an engine of the vehicle, and the control means is further adapted to transmit said brake actuation signal when said third signal indicates that said ignition status is OFF.

Preferably, the control means further receives a fourth signal indicative of a speed of the vehicle, and the control means is further adapted to transmit said brake actuation signal only if said third signal indicates that the vehicle speed is below a predetermined speed.

Preferably, the system further includes a housing for housing the control means and having input and output terminals for receiving and transmitting signals, the housing being located interior of a vehicle, preferably cabin within reach of a driver seated in said driver's seat. Preferably, the housing includes a user interface having manual input means for allowing the driver to input a brake de-activation instruction to said control means. Preferably, the manual input means includes a keypad and said brake de-activation instruction will only be accepted by said control means if the driver first inputs into said keypad a security code.

Preferably, the housing further includes a maintenance switch adapted to partially disable said control means and prevent transmission of said brake actuation signal when said maintenance switch is ON.

Preferably, if said ignition status is ON and said maintenance switch is ON, said control means is adapted to transmit an alarm signal. Preferably, the housing includes visible alarm indication means and audible alarm indication means, each responsive to said alarm signal of said control means.

Preferably, said vehicle is a truck or other heavy vehicle, such as a bus or heavy loading vehicle is used in mining operations. Preferably, the brake actuation mechanism is an emergency brake actuation mechanism.

The present invention further provides a method of automatically actuating brakes of a vehicle, including the steps of:

receiving a first signal indicative of whether a driver's seat of the vehicle is occupied or not;

receiving a second signal indicative of whether a driver's door of the vehicle is open or closed; and

transmitting a brake actuation signal to a brake actuation mechanism of the vehicle when said first and second signals indicate that said driver's seat is not occupied and said driver's door is open.

The present invention further provides a vehicle having an automatic brake actuation system, including:

seat sensor means for providing a seat output signal indicating whether a driver's seat of the vehicle is occupied or not;

door sensor means for providing a door output signal indicating whether a driver's door is open or closed;

control means adapted to receive said seat and door output signals and to actuate emergency breaks of the vehicle when said seat output signal indicates that said driver's seat is not occupied and said door output signal indicates that said driver's door is open.

Advantageously, embodiments of the invention reliably ensure that the park brake is activated when a driver alights from a vehicle, which will enhance the safety of persons and property.

Advantageously, the system can include a maintenance override switch to deactivate the system when the emergency brakes of the vehicle are under maintenance.

### BRIEF DESCRIPTION OF THE DRAWINGS

In order that the invention may be more readily understood, embodiments are described herein with reference to the drawings, wherein:

FIG. 1 is a diagram of an automatic brake actuation system for vehicles or the like in accordance with a first embodiment of the invention;

FIG. 2 is a block diagram of a control unit of the automatic brake actuation system of FIG. 1;

FIG. 3 is a wiring diagram for the automatic brake actuation system;

FIG. 4 is a wiring schematic for a control panel and external maintenance switch of the automatic brake actuation system;

FIGS. 5A and 5B form an interconnected schematic circuit diagram of the control unit;

FIGS. 6A and 6B are logic tables describing brake and beeper logic functions;

FIG. 7 is a plan view of a housing for the control unit;

FIG. 8 is a schematic circuit diagram of a test rig for testing installation wiring of the automatic brake actuation system; and

FIG. 9 is a schematic circuit diagram of a test rig for testing the functions of the control unit.

### DETAILED DESCRIPTION

Like alphanumeric references among the drawings indicates like or related functions.

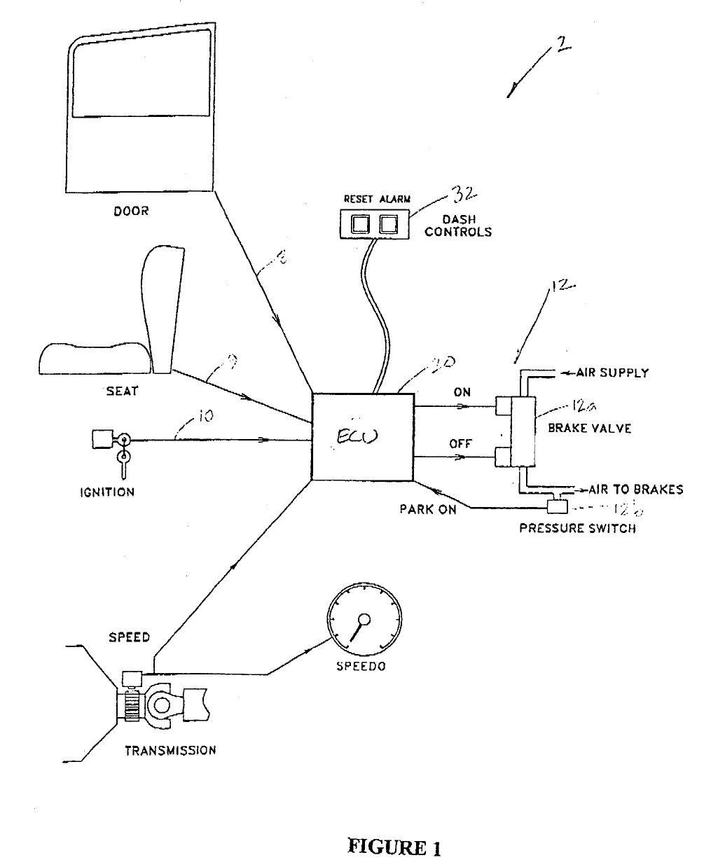

Referring to FIG. 1 of the drawings, there is shown conceptual diagram of an automatic brake actuation system 2 for vehicles such as a semi-trailer.

The automatic brake actuation system 2 includes an electronic control unit (ECU) 20 arranged to receive a number of input signals and transmit brake actuation and deactivation signals to a brake actuation mechanism 12. The brake actuation mechanism 12 includes a solenoid valve 12a fitted in a pneumatic brake line for controlling pneumatic actuation of the pneumatic brakes. If the brakes are hydraulic or otherwise actuated, an alternative form of control valve may be used in the actuation mechanism 12. In order for the ECU 20 to determine whether the brakes have been actuated, a pre-existing pressure switch 12b connected in a brake fluid line is connected to the ECU 20. If no pressure switch exists in the vehicle brake fluid line, a suitable pressure sensor (eg. a normally closed in-line low pressure 4-10 psi sensor switch) is installed in that line and its output is connected to the ECU 20.

The solenoid valve 12a is fitted into the vehicle brake air line at installation of the system 2 and is a double acting valve, preferably a CD7-24 Rexroth pneumatic solenoid valve with 12/24 volt actuation inputs. To put the brakes on, the solenoid valve 12a is actuated to let air out of the air line.

The ECU 20 receives input signals in the form of a door signal 8, a seat signal 9, an ignition signal 10 and a speed signal 11. The door signal 8 is drawn from the pre-existing door light circuit which is installed in most vehicles and which turns on when the door is opened. The seat signal 9 is derived from a pressure sensor installed in the seat as part of the installation of the automatic brake actuation system 2. Suitable pressure sensors for installation in the seat include:

A 121-BP (welded in) centroflex ribbon switch with 8 to 12 ounce sensitivity;

A N0-1R rectangular normally open or normally closed sensing cell with 8 to 12 ounce sensitivity; and

A CVP commercial duty switching mat with 8 to 12 ounce sensitivity.

The ignition signal 10 is taken from a pre-existing control line which provides an indication of the ignition status of the vehicle. Similarly, the speed signal 11 is taken from a pre-existing output line of a pre-existing vehicle speed sensor (such as that which feeds into the vehicle speedometer). A throttle signal (not shown) may also be received by the ECU 20 to indicate whether the vehicle engine is in an idle state.

The ECU 20 has connected thereto a control panel 32 having buttons and indicators thereon so as to act as a user interface for the driver. The control panel 32 may include a numeric or alphanumeric keypad (not shown) for allowing the driver to input a security code before the parking brake can be released. Thus, once the brake is actuated, a valid security code must be entered into the ECU 20 (via the keypad and control panel 32) before the brake release button will function normally. This embodiment requires additional logic functionality in the ECU 20 but this can be done by persons skilled in the art.

The seat signal 9 is activated when the driver vacates the seat. This signal may be time delayed (eg. by 2 seconds) to see if it remains steady before being allowed to pass, to reduce the possibility of inadvertent application of the brakes due to the driver momentarily leaving the seat in a situation where the driver's door might be slightly ajar or the door sensor is malfunctioning. If the switch state changes back to its original setting before the 2 seconds, the seat signal is not transmitted. The door signal 8 is activated when the driver's door is opened.

The seat switch and door switch are wired such that the seat and door signals must be activated for the system to activate. Normally, the driver would open the door to intentionally vacate the vehicle. The seat signal 9 and throttle or speed signals 11 are also used by the ECU 20 to detect if the driver has, for instance, left the engine running while climbing into the back of the vehicle, for example such as in prime movers with a sleeper cab and those with turbochargers that have an engine timer switch to allow the turbocharger to spin down before engine shutdown.

The input from the pressure switch/sensor 12b to the ECU 20 is used to prevent the system from transmitting the brake actuation signal if the parking brake is already on and to reset the system logic once the brakes are released.

A maintenance override switch is provided to allow maintenance to be performed on the braking system by preventing transmission of the brake actuation signal. If the ignition is off and the maintenance override switch is off, the park brake will be activated. This does not require the seat or door switches to be activated. The throttle signal sensor is derived from an existing throttle and will be activated when the throttle is at idle as this is the condition in most cases when a driver alights from the vehicle and chooses to leave the engine running. This signal is optional, however, as it should be superfluous for actuating the parking brake in most situations. The ignition is monitored to activate the park brake when the engine is shutdown and the park brake has not been selected. The ECU 20 also monitors the above plus throttle position or vehicle speed to activate the park brake. The timing, delay functions are also incorporated in the control unit.

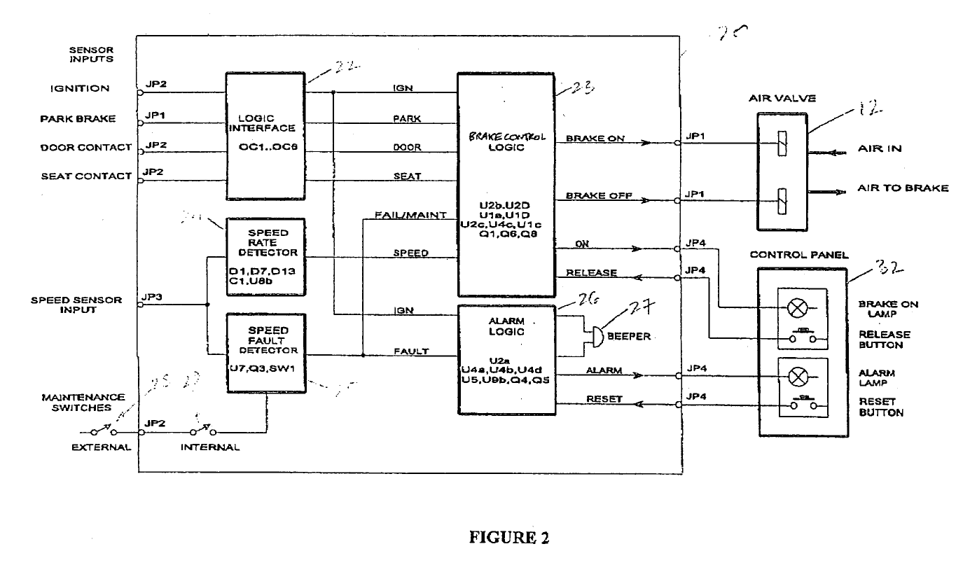

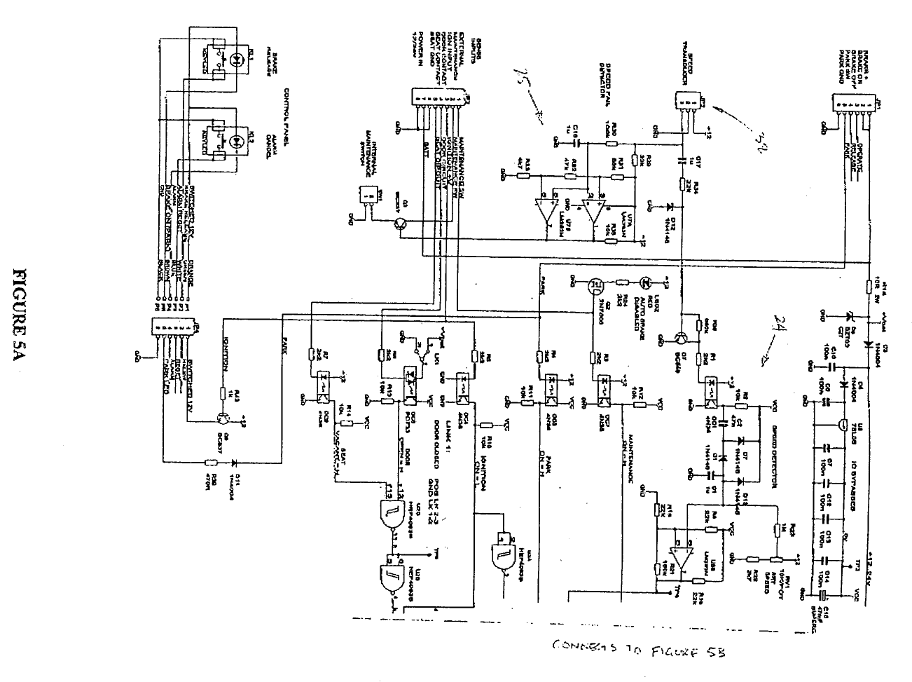

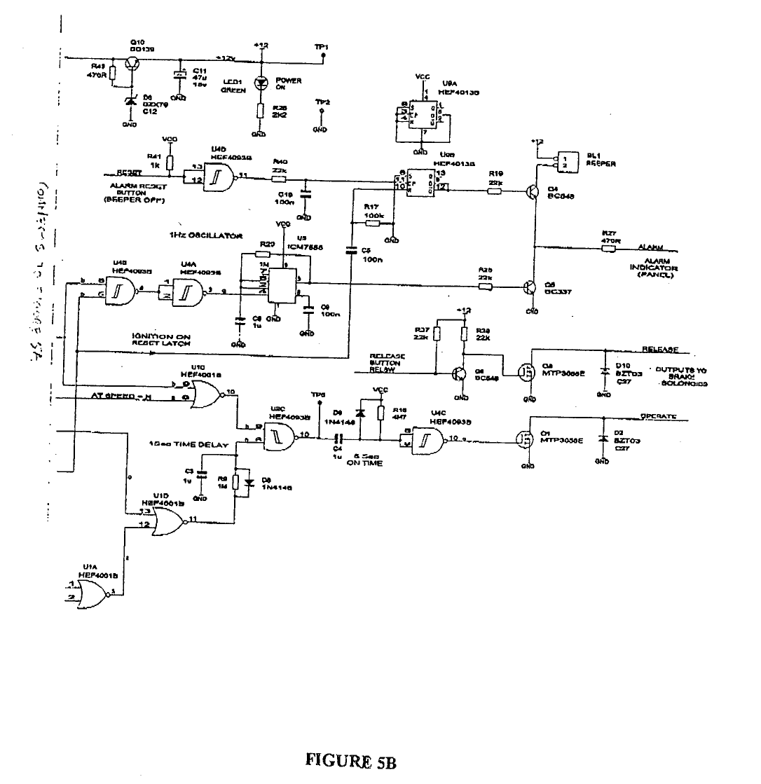

Reference will now be made to FIGS. 2, 5A and 5B, in which the ECU 20 is shown in greater detail.

FIG. 2 is a block diagram of the ECU 20, showing functional blocks therein and external electrical connections. The connection references JP1 to JP4 correspond to the connectors JP1 to JP4 shown in FIGS. 5A and 5B. A control panel 32 is connected by connector JP4 to the ECU 20. The control panel 32 has a release button for releasing the parking-brake and an indicator light (preferably in the form of an LED) to indicate when the parking brake is activated (ON). If the release button is pressed and the conditions for actuating the parking brake still exist, the brakes will not be released. The control panel 32 also has an alarm indicator light (preferably in the form of an LED) and an alarm reset button. The alarm indicator will flash when, due to a fault or maintenance condition, the ECU 20 is prevented from transmitting the brake actuation signal and the ignition is ON. Transmission of the alarm indication signal to the control panel 32 is provided by an alarm logic module 26 within the ECU 20. The alarm logic module 26 also controls an audible alarm beeper 27, which sounds simultaneously with the flashing alarm indicator when the alarm condition exists. The reset button on the control panel 32 sends a signal back to the alarm logic module 26 to silence the beeper 27. However, the alarm indicator will still continue to flash while the alarm condition exists, irrespective of whether the beeper 27 is silenced.

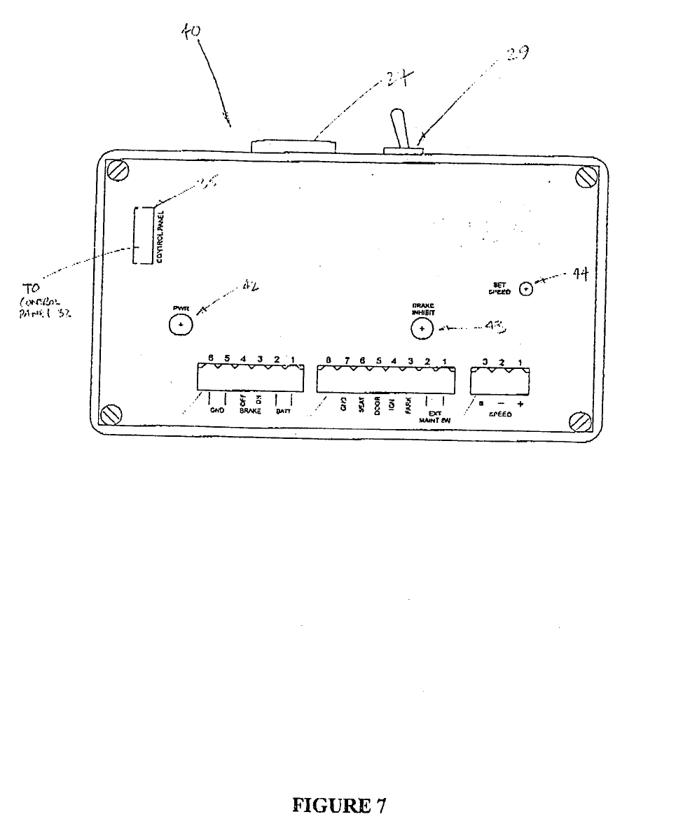

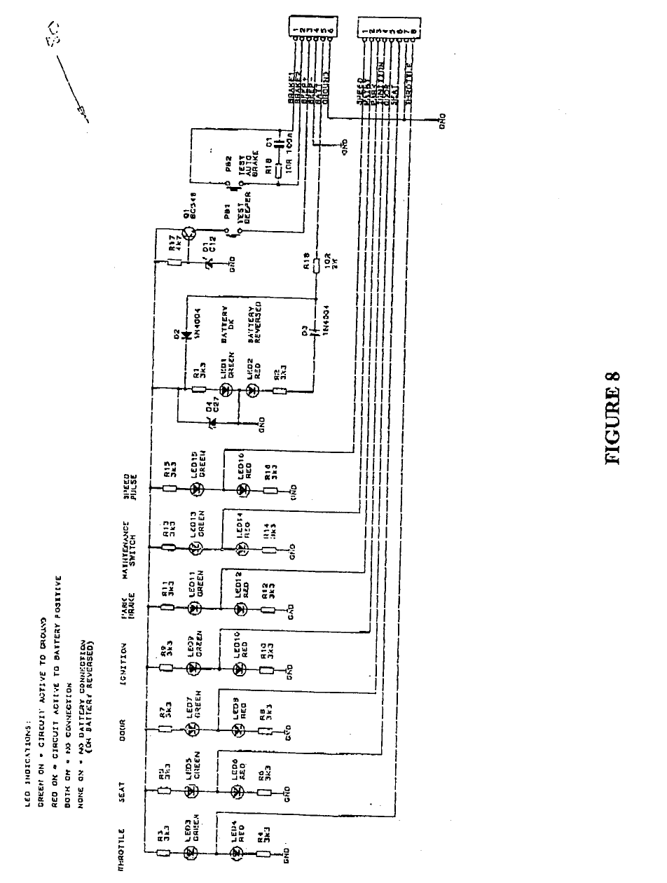

At least one maintenance switch 29 is provided on the ECU 20 for preventing transmission of the brake actuation signal while the brakes are undergoing maintenance. This internal maintenance switch 29 is provided on the housing of the ECU 20 (shown in further detail in FIG. 7) and may be complimented by an external maintenance switch 28, connected in series, located in a more practically accessible location.

The speed signal 11 is received as a speed sensor input by a speed rate detector module 24 and speed fault detector module 25. The operation of these modules is described further below. The speed fault detector module 25, on detecting a fault, provides a maintenance condition and, if the maintenance condition is ON (ie. if the maintenance switch is on or if the speed sensor input is not being received), it outputs a fault condition signal to brake control logic module 23 and alarm logic module 25.

The speed rate detector 24 receives the speed signal 11 input and compares it to a set speed threshold. If the input signal indicates that the vehicle speed is above the set threshold, an output of the speed rate detector 24 is provided to brake control logic module 23 and the brake actuation signal is prevented from being transmitted.

The brake control logic module 23 receives input from the speed fault detector 25 and speed rate detector 24 and from the external signal sources (ignition, pressure switch, door contact and seat contact) and issues the brake actuation and deactivation signals according to the appropriate conditions. The logic of the brake control logic module 23 is described further below, with reference to circuit elements shown in the schematic circuit diagram of FIGS. 5A and 5B.

Logic Interface (22):

This section provides protected and isolated connections from vehicle wiring points into the Electronic Control Unit (ECU) 20 so that transients and pulses in vehicle wiring are prevented from damaging the electronics in the ECU 20. This function is provided by the opto-couplers OC1 to OC6.

Speed Detector (24):

This comprises a charge-pump circuit D1, D7, D13 and C1 driving the voltage comparator U8B. Above a set speed (adjusted with trimpot RV1) the comparator output goes logic HIGH which is processed in the brake control logic section 23 to inhibit emergency brake actuation. In effect, the control unit 20 cannot apply the brake system at any speed above the set threshold. In practice the set-point is adjusted by the trimpot RV1 (also shown as a manual set speed adjustment input 44 in FIG. 7) for speeds above which it would be considered dangerous to apply the park brake

Speed Fault Detector (25):

This is a simple window comparator circuit U7A, U7B which turns OFF transistor Q3 if the connection from the speed transducer is a short-circuit or open circuit (or if the plug JP3 becomes disconnected). Q3 transistor is normally ON and is connected in a series circuit with the internal and external MAINTENANCE SWITCHES (29, 28). Should any of these connections be opened (Q3 OFF or either switch OFF) the emergency brake actuation function is inhibited and the alarm sounds (when ignition is ON).

Brake Control Logic (23):

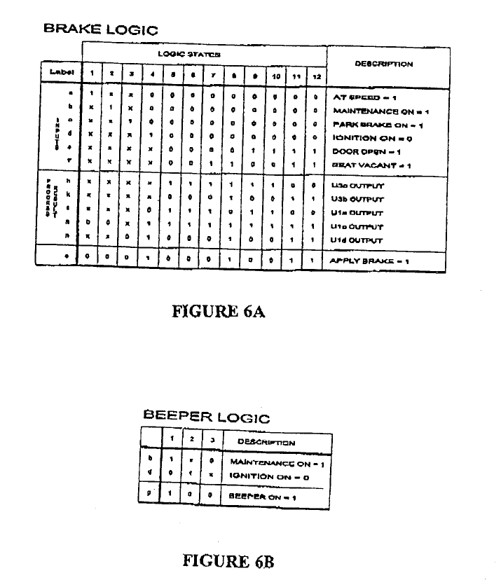

This section comprises an array of logic gates contained in Integrated circuits U1, U2 and U4. The gates provide a boolean logic function as defined by the BRAKE LOGIC truth table in FIG. 6A. Capacitor C3, resistor R9, and diode D8 comprise a timing circuit which prevents interference pulses from causing false operation. Capacitor C4, resistor R16, and diode D9 comprise another timing circuit whose function is to convert the logic output of the logic block into a timed actuation pulse for the brake control valve (continuous activation of the valve solenoid can lead to overheating). Transistors Q1 and Q8 convert the low level logic states into substantial current outputs to reliably operate the control valve.

Alarm Logic (26):

This section includes the logic gates U4A, U4B and U4D with timer oscillator U5 and trigger flip-flop U9B. Gate U4B provides the boolean logic function “Ignition ON AND Maintenance or Fault condition ON”. In this state oscillator U5 is activated which causes the beeper to intermittently sound and the alarm indicator LED lamp in the control panel to flash On and Off. When the RESET button on the control panel is pressed, the trigger flips flop U9 is reset, which stops the beeper from sounding (Transistor Q4 is turned OFF). However transistor Q5 is still being turned ON by the oscillator U5 so the LED in the control panel remains flashing until the alarm state is restored to normal (ie., the speed fault is fixed or the Maintenance switches restored) for normal operation.

The backwards “Z” shape in the logic circuit symbols indicate that the inputs include a schmidt trigger response, which means that if the input is slowly rising or falling the circuit converts this into sharp LOW-to-HIGH or HIGH-to-LOW transitions at the schmidt trigger points. There is also hysterisis built into the schmidt function in that the rising waveform triggers at a higher level than the falling waveform.

Brake Operation:

The brake is OPERATED (ie. the OPERATE signal is output to the solenoid 12a) when transistor Q1 turns ON;

U4C output is logic HIGH to turn Q1 ON;

U2C output is logic LOW to drive U4C output HIGH via 5-second ON timer RC circuit C4/R16; For this condition to occur inputs to U2C must BOTH be HIGH (labels ‘m’ and ‘n’ on the diagram);

Label ‘m’ (U1C output) is HIGH if BOTH inputs MAINTENANCE and AT SPEED (Labels ‘b’ and ‘a’) are LOW. This means that BOTH Maintenance must be OFF and the speed detector NOT AT SPEED (lower than the set speed threshold). In other words if these conditions are not met then the brake output cannot occur.

Label ‘n’ (U1D output via timer circuit C3/R9) is HIGH if BOTH inputs PARK and U1A output are LOW.

U1A gates the output of Ignition with the result of U2D in a NOR function:

A HIGH state on either input results in a LOW state on the output

Conversely is LOW state on BOTH inputs result in HIGH state on the output.

This means that U1A output will go LOW if the ignition is turned OFF or BOTH the Seat is vacant AND the door is OPEN.

U2B has both inputs connected together so this gate is a simple inverter. In other words if U2D output is HIGH then U2B output is LOW and vice-versa.

U2d gates the door and seat logic in a NAND function:

Output is LOW only if the door is open and the seat is VACANT;

Conversely output is HIGH if EITHER door is CLOSED; OR seat is OCCUPIED.

Taken altogether the logic as described above means:—

The brake will OPERATE (ie. the actuation signal will be transmitted to the brake solenoid valve) if:

Speed is LOW and Maintenance is OFF (gate U1C)

AND

| PARK is NOT ON and | | | ) UID |
|---|---|---|---|
| IGNITION is NOT ON | and | ) UIA | ) |

DOOR is OPEN and SEAT is VACANT U2D, U2B)

Reference to the Truth table BRAKE LOGIC in FIG. 6A gives a more graphic way of looking at the logic depicting the result for all possible states of excitation at the inputs. The symbol ‘x’ means that the logic state doesn't matter.

Brake Releases:

Brake is released when Transistor Q8 turns ON;

Transistor Q6 OFF turns Q8 ON;

Ground at Q6 base turns Q6 OFF;

The RELEASE button on the control panel provides a ground at the Q6 base terminal.

The release function will always override the operate function since operation is always only a brief timed ON pulse. The operate function will only repeat if the non-operate logic conditions are restored and then a new operate condition occurs.

Alarm Logic:

The alarm function comprises the alarm beeper and the alarm LED indicator on the control panel.

The alarm beeper sounds if transistors Q5 AND Q4 are both turned ON.

The alarm led on the control panel lights if only Q5 is turned ON.

Transistor Q4 is turned ON if flip-flop U9B is triggered into its RESET state.

Turning IGNITION ON causes a HIGH level at the output of U2A which appears as a RESET pulse on U9 pin 10 via pulse RC circuit C5/R17.

Transistor Q5 is turned ON when the oscillator U5 output goes HIGH. If the RESET pin 4 of U5 is HIGH then the oscillator runs at about 1 Hz so Q5 is turned ON/OFF at about a 1 Hz rate. Thins the beeper “beeps” and the LED flashes in the Alarm ON state.

U5 is taken out of RESET by U4A output HIGH resulting from U4B output LOW. This can only occur if BOTH inputs to U4B are HIGH (i.e. BOTH Ignition and Maintenance are ON). Hence the Alarm occurs if Ignition is turned ON whilst the control unit is still switched to the MAINTENANCE mode (or a fault in the speed sensor has occurred).

The alarm is RESET by pressing the RESET button on the control panel 32. This provides Logic LOW into U4D which then gives logic HIGH to the CP (clock) input of flip-flop U9B. This trips U9B into its alternate state and since it has already been triggered into its alarm state then the alarm is tripped OFF (transistor Q4 is turned OFF so the beeper 27 is silenced).

The alarm RESET signal only silences the beeper 27. The true alarm OFF state can only be achieved when the conditions giving rise to the alarm are restored to normal operation.

Power Supply to the ECU

The ECU 20 can be powered front either 12 v or 24 v vehicle battery systems. Power is connected to the ECU by connections at JP2 pins 7 and 8. The power connection has to be to a permanent battery. In the Idle condition system does not consume significant current, so the permanent power connection has a neglible effect on the battery when the vehicle is not running.

Input over-voltage and reverse-voltage protection is provided by diodes D5 and D3.

Diode D4 feeds a +5 v regulator which provides +5 v to all logic devices in the ECU. A capacitor C15 (“Supercap”) provides storage of the logic voltage in the event that the battery voltage falls briefly such as during engine starting.

Transistor Q10 and diode combine to D6 provide a 12 v regulation function so that a constant 12 v is provided to the non-logic sections of the ECU for either 12 or 24 v inputs.

The input signals may be varied as long as they are appropriately accounted for in the circuit to obtain the same result. This will allow for the flexibility in achieving the best electrical loading for the circuit.

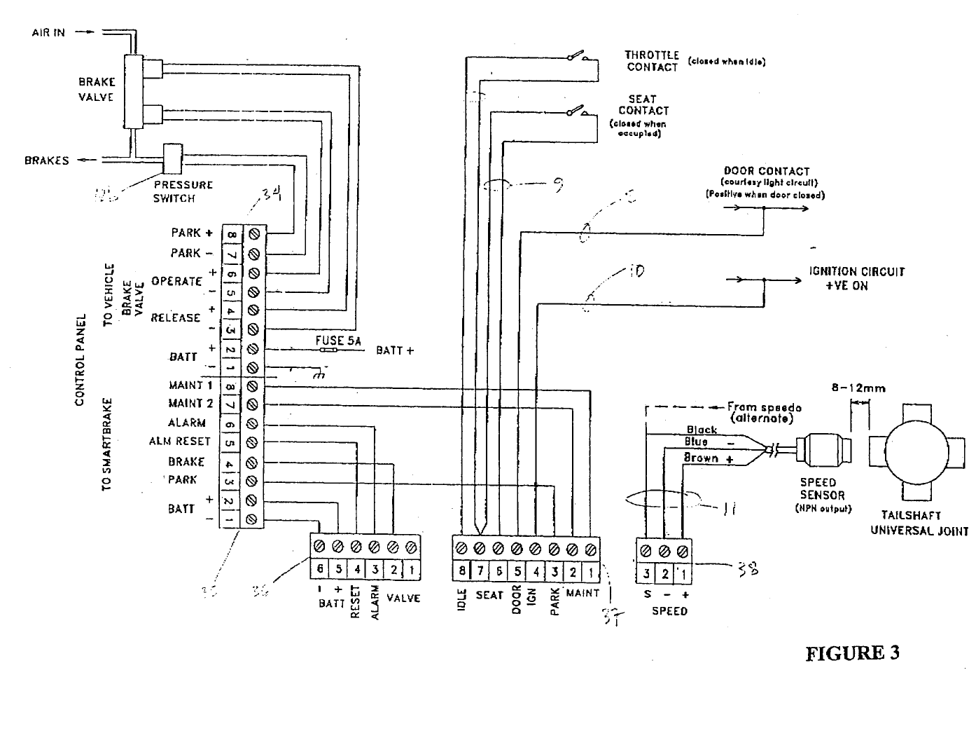

FIG. 3 is a wiring diagram illustrating the derivation of ECU input signals 7, 8, 9, 10 and 11 from the throttle contact, door contact seat contact, ignition circuit and speed sensor, respectively. The signal lines are connected to modular connectors 37 and 38. Modular connector 37 is in turn connected to a modular connector 35 which provides output to the control panel 32. A modular connector 34 is also provided, which connects to the actuator mechanism 12, including solenoid 12a and pressure search 12b. Each of the modular connectors 34 to 38 are provided on a housing 40 (shown in FIG. 7) and are electrically connected to the ECU 20.

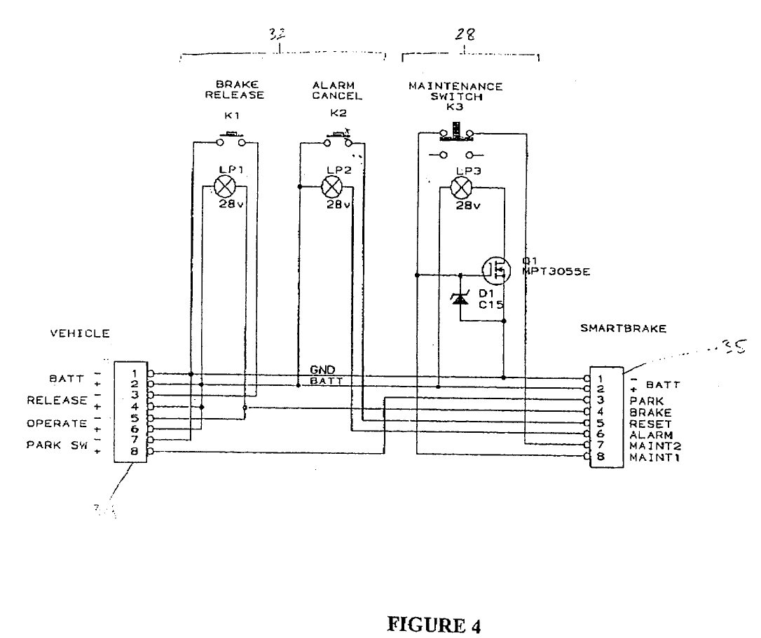

FIG. 4 is a wiring diagram for the control panel 32, showing the brake release button K1, indicator light LP1, the alarm cancel button K2 and alarm indicator LP2. Optional external maintenance switch 28 is also shown, connected to modular connector 35.

Reference in FIGS. 3 and 4 to “Smart Brake” is a reference to the ECU 20.

FIGS. 6A and 6B illustrate the logic states under which the brake actuation signal will be transmitted and the audible beeper will be actuated, respectively. The alphabetic state labels in the tables correspond to the signal states oil the logic lines in FIGS. 5A and 5B. These logic tables are self-explanatory to those skilled in the art.

Referring now to FIG. 7, the ECU 20 is housed in a small box like housing 40. The housing 40 has the modular connectors 36, 37 and 38 located on an outer surface (cover plate) thereof for receiving various signal inputs and transmitting the brake actuation signal to actuation mechanism 12. A ribbon connector for connecting to control panel 32 is also provided, and this is designated by reference numeral 35 to indicate the relationship to modular connector 35 shown in FIGS. 3 and 4.

A power indicator light 42 is provided on the cover plate to indicate that the automatic brake actuation system 2 is receiving power. A brake inhibit indicator 43 is also provided, to indicate that the maintenance condition in on. A small set speed dial 44 is also provided on the cover plate of the housing 40. This set speed dial 44 connects directly to the trimpot RV1 (shown in FIG. 5A) for adjusting the speed threshold above which the brake actuation signal is inhibited from being transmitted to the actuator mechanism 12. A small analog scale may be provided around the set speed dial 44 for indicating the set speed for the dial position.

An audible output of the beeper 27 is also provided on the housing 40, as is the physical switch mechanism for the internal maintenance switch 29.

Further features of the housing 40, ECU 20 and control panel 32 may include indicators to indicate the status of the maintenance switch, the set speed threshold or other logical control states which it may be of interest to display to a driver or other user of the automatic brake actuation system 2.

FIG. 8 is a schematic circuit diagram of a test rig 80 for testing the installation wiring of the automatic brake actuation system 2. The test rig 80 is intended to receive the modular connector inputs for connectors 36 and 37 and provides red and green LED indicators for indicating the status of the signal inputs.

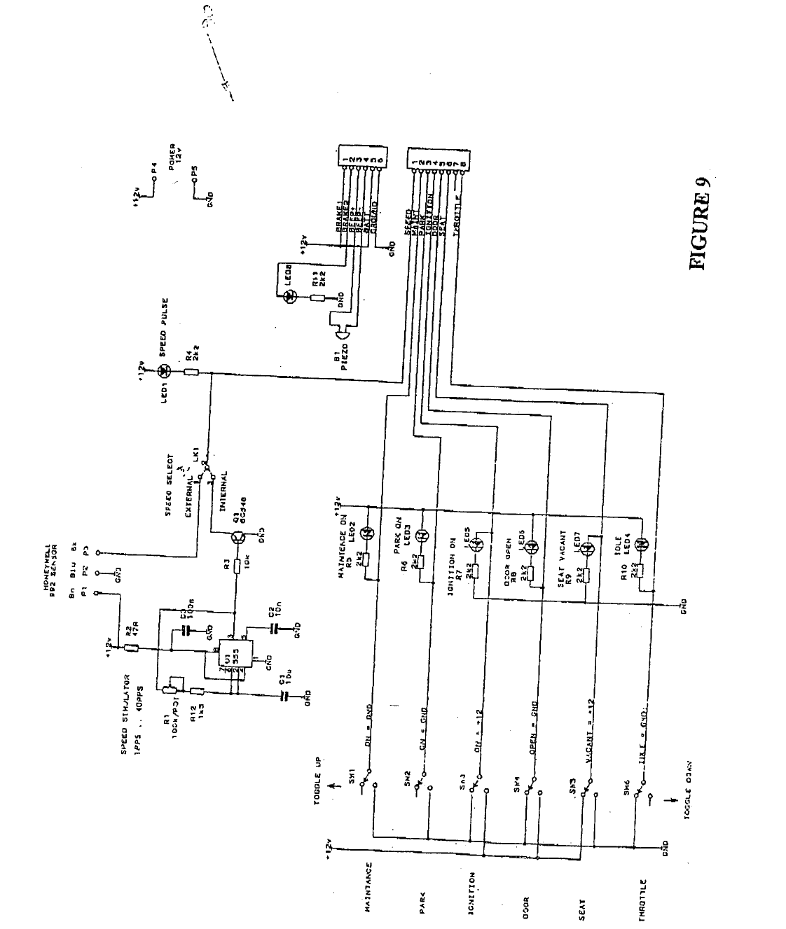

In FIG. 9, a test rig 90 is shown for testing the functions of ECU 20. The test rig 90 has plug connectors for plugging into modular connectors 36 and 37 of housing 40 and has various switches and indicators for providing test input signals to the ECU 20 and indicating the test condition in response.

The automatic brake actuation system 2 is described herein on the basis that it is retro-fitted to a vehicle, but the principles and operation of the system 2 may be equally realised by an embodiment which is built into the vehicle during manufacture of the vehicle. If the system 2 is built into the vehicle during manufacture, then the functions of the ECU 20 may be programmed into an ASIC or other hardware chip for integration into the engine management system of the vehicle.

It can be seen that the use of a plurality of driver sensors and vehicle sensors and logically combining the received signals provides an automatic park brake system which is only activated when it is extremely probable to be the required action. It is therefore expected that this system will decrease and possibly eliminate the unfortunate number of accidental deaths that occur when drivers of large vehicles forget to initiate the park brake before alighting.

It should be understood that the above description is of the preferred embodiments and that variations or modifications apparent to persons skilled in the art are included within the spirit and scope of the invention.

The claims defining the invention are as follows:

1. An automatic parking brake actuation system for a truck or other heavy vehicle, including:
control means for receiving a first signal indicative of whether a driver's seat of the vehicle is occupied or not and for receiving a second signal indicative of whether a driver's door of the vehicle is open or closed, wherein the control means is adapted to transmit a brake actuation signal to a parking brake actuation mechanism of the vehicle when said first and second signals indicate that said driver's seat is not occupied and said driver's door is open.

2. The system of claim 1, wherein the control means further receives a third signal indicative of an ignition status of an engine of the vehicle, and wherein the control means is further adapted to transmit said brake actuation signal when said third signal indicates that said ignition status is OFF.

3. The system of claim 1, wherein the control means further receives a fourth signal indicative of a speed of the vehicle, and wherein the control means is further adapted to transmit said brake actuation signal only if said third signal indicates that the vehicle speed is below a predetermined speed.

4. The system of claim 1, further including a housing for housing the control means and having input and output terminals for receiving and transmitting signals, the housing being located interior of a vehicle cabin.

5. The system of claim 4, wherein the housing has a user interface panel associated therewith and having manual input means for allowing the driver to input a brake de-activation instruction to said control means.

6. The system of claim 5, wherein said manual input means includes a keypad and said brake de-activation instruction will only be accepted by said control means if a valid security code is inputted into said keypad.

7. The system of claim 2, further including a housing for housing the control means and having input and output terminals for receiving and transmitting signals, wherein the housing further includes a maintenance switch adapted to prevent transmission of said brake actuation signal when said maintenance switch is ON.

8. The system of claim 7, wherein if said ignition status is ON and said maintenance switch is ON, said control means is adapted to transmit an alarm signal.

9. The system of claim 8, wherein the housing has a user interface panel associated therewith, which includes visible alarm indication means on said user interface panel responsive to said alarm signal of said control means.

10. The system of claim 8, wherein the housing includes audible alarm indication means responsive to said alarm signal of said control means.

11. The system of claim 1, wherein the system is retrofitted to the vehicle.

12. A method of automatically actuating parking brakes of a truck or other heavy vehicle, including the steps of:
receiving a first signal indicative of whether a driver's seat of the truck or other heavy vehicle is occupied or not;
receiving a second signal indicative of whether a driver's door of the truck or other heavy vehicle is open or closed; and
transmitting a brake actuation signal to a brake actuation mechanism of the truck or other heavy vehicle when said first and second signals indicate that said driver's seat is not occupied and said driver's door is open.

13. A method of installing a vehicle safety system, including the steps of:
installing a seat sensor in a driver's seat of the vehicle;
installing the automatic brake actuation system of claim 1 in the vehicle and connecting the system to a power supply of the vehicle;
connecting the seat sensor to the control means to supply said first signal;
connecting an output of a door sensor to the control means to supply said second signal.

14. The method of claim 13, further including mounting a control panel of the automatic brake actuation system inside a cabin of the vehicle within reach of a driver of the vehicle, the control panel being electronically connected to the control means, whereby the driver can input into the control means a brake de-activation signal.

15. A vehicle having an automatic brake actuation system, including:
seat sensor means for providing a seat output signal indicating whether a driver's seat is occupied or not;
door sensor means for providing a door output signal indicating whether a driver's door is open or closed;
control means adapted to receive said seat and door output signals and to actuate emergency breaks of the vehicle when said seat output signal indicates that said driver's seat is not occupied and said door output signal indicates that said driver's door is open.

16. The vehicle of claim 15, wherein the control means further receives an ignition signal indicative of an ignition status of an engine of the vehicle, and wherein the control means is further adapted to transmit said brake actuation signal when said third signal indicates that said ignition status is OFF.

17. The vehicle of claim 15, wherein the control means further receives a speed signal indicative of a speed of the vehicle, and wherein the control means is further adapted to transmit said brake actuation signal only if said third signal indicates that the vehicle speed is below a predetermined speed.

18. The vehicle of claim 15, wherein the vehicle is a truck or other heavy vehicle.

19. The vehicle of claim 16, further including a housing for housing the control means and having input and output terminals for receiving and transmitting signals, wherein the housing further includes a maintenance switch adapted to prevent transmission of said brake actuation signal when said maintenance switch is ON.

20. The vehicle of claim 19, wherein if said ignition status is ON and said maintenance switch is ON, said control means is adapted to transmit an alarm signal.
